(19) United States
(12) Patent Application Publication
(10) Pub. No.: US 2010/0105305 A1
(43) Pub. Date: Apr. 29, 2010

(54) Rabbit and poultry cervical vertebral dislocation apparatus

(76) Inventor: Salvatore George Pizzurro, West Grove, PA (US)

Correspondence Address: SALVATORE G. PIZZURRO, 2 ELLIOTT DRIVE, WEST GROVE, PA, 19390, US

(21) Appl. No.: 12/589,643

(22) Filed: Oct. 27, 2009

Related U.S. Application Data
(60) Provisional application No. 61/193,090, filed on Oct. 27, 2008.

(51) Int. Cl. A22B 3/10; A22B 3/00; A22B 3/08

(52) U.S. Cl. 452/52

(57) ABSTRACT

A rabbit and poultry cervical vertebral dislocation device more simply put “neck breaker” comprises a cylindrical rod attached to an L-shaped base frame and mounting flange. The apparatus is mounted to a solid rigid structure by appropriate means. A fixed rod and base frame forming an inverted wedge to receive the animal's neck into the apparatus. With the animals head wedged between the rod and the base frame, the operator holds the animal by the back legs or feet and pulls upward and back thus separating the skull from the spine humanely and instantly stunning and killing the animal by causing irreparable damage to the brain stem, spinal cord, arteries and spine. The animal is stunned by the trauma and dies as a result of the brain being separated from the rest of the body and massive internal bleeding.

### FIELD OF INVENTION

The present invention relates to a small animal neck breaker and cervical vertebral dislocation apparatus used mainly for humanely and instantly euthanizing or slaughtering small domestic livestock animals bred purposely for their meat.

### BACKGROUND OF THE INVENTION

This invention relates in general to a rabbit euthanasia and slaughtering apparatus and is more particularly described as an apparatus for slaughtering rabbits and the like, by means of cervical dislocation, whereby in the “hyper extension” method (1) the operator places the animal into the device opening, slides the animal toward the closed end of the apparatus and subsequently pulls the animal forcefully while hyper extending the neck until a separation occurs at a critical point of the cervical spine causing irreparable damage to the cervical vertebrae, causing instant incapacitation and a quick humane death without causing undue stress, anxiety, or pain to the animal.

### PRIOR ART

No prior art is known for this invention.

### SUMMARY OF THE INVENTION

An important object of the invention is to provide an opening for receiving the head and neck of the animal to be slaughtered, and be constructed of materials strong enough to withstand its use while ensuring safety for the operator and a quick humane death for the animal.

A further object of the invention is to provide two opposing rigid structures forming an inverted wedge shape which holds the animal in place and tightens its hold as the operator pulls the animal by its rear legs.

A still further object of the invention is to provide a rigid angled stop at the rear of the inverted wedge with the opposing rigid structure being at a sharp angle, this with two opposing rigid structures comprising the inverted wedge.

A still further object of the invention is to provide the two opposing rigid structures comprising the inverted wedge to be running parallel, but on different planes, this with the angle of the rear stop, and all geometric intersections, converging causing the head of the animal to twist in such a way that the separation occurs at a critical point of the cervical spine causing irreparable damage to the cervical vertebrae, followed by instant incapacitation and a quick humane death without causing decapitation.

A still further object of the invention is to provide the two opposing rigid structures comprising the inverted wedge which is easily adjustable without the need for special tools in order to make the opening of the inverted wedge wider or narrower accepting various sized animals and depending on the operators needs.

A still further object of the invention is to provide a rabbit slaughtering apparatus which is constructed of steel, plastic, carbon fiber, or other similar material cut and shaped to the proper form to provide a portable, light, strong, efficiently operating device which will not rust or corrode under normal conditions and is easy to clean and maintain.

Another object of the invention is to provide a rabbit slaughtering apparatus which is generally of new and improved construction, and is characterized by simplicity of design as well as ease and facility of assembly and also gives the operator unlimited choices as to where to install the device and ways of using the apparatus which best suits the operators needs.

Other aspects of the invention and various advantages and characteristics of the Rabbit slaughtering apparatus will be apparent from the consideration of the following detailed description.

### BRIEF DESCRIPTION OF THE DRAWINGS

The invention consists of several novel features which are hereinafter described and made apparent by the drawings which accompany and form a part of this specification or disclosure and in which like letters and numerals of reference denote corresponding parts throughout the several views.

FIG. 1 is a perspective view of the rabbit slaughtering device constructed in accordance with the present invention.

FIG. 2 is a perspective view of the rabbit slaughtering device constructed in accordance with the present invention.

FIG. 3 is a sectional view of the device shown in FIG. 1

FIG. 4 is an elevation of the structure in FIG. 1.

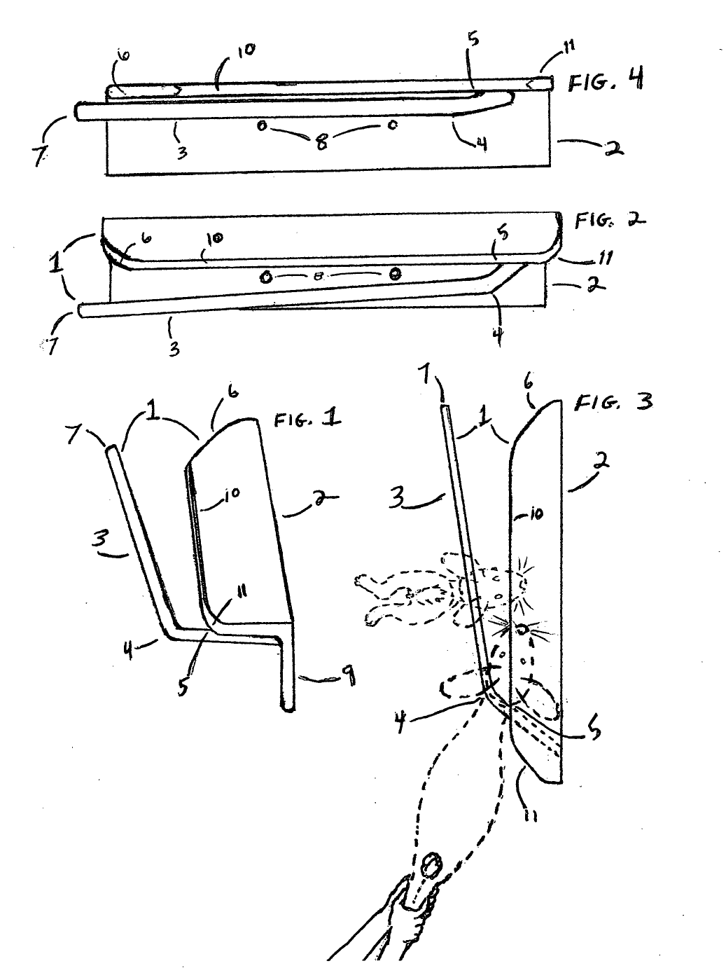

At times it may be desired to slaughter the rabbit or any other small animal by utilizing the “Sharp Pull” method (2) whereby the operator inserts the animals head into the device then slides the animal toward the closed end just until the animal's neck fits snuggly in to the device, then positioning the body of the animal perpendicular to the device, grabbing the rear legs or any suitable part of the animal then swiftly and sharply pulling the animal upward, using your free hand to hold the animal in place thus breaking the neck, instantly and humanely incapacitating, and killing the animal. The present invention provides a portable device preferably made of steel or any rigid materials. This invention can be made by joining individual parts or components or using a mold and pouring a suitable material like aluminum, plastic or any similar materials to form a one piece device. It also provides a light, strong easily operated device which is easily secured to and detached from any suitable support so that it is readily portable.

### DETAILED DESCRIPTION OF THE INVENTION

Referring now more particularly to the drawings, an inverted wedge shaped structure 1 for receiving the animals head is formed of steel or similar rigid material and comprised of two readily available or produced materials shaped and secured together by any available means to provide a supporting base and an outwardly curved rod projection which can be round or square shaped.

The supporting base 2 of the device made from a piece of angled material in the shape of an “L” is the support for which the rod 3 is attached, by means mechanical fasteners, welding, epoxy and similar means. The angle 4 at which the rod 3 is bent is a unique aspect of the device. The angle 5 at which the rod converges with the supporting base 2 is another unique aspect of the device. The receiving end 6 of the supporting base 2 is chamfered allowing for smooth insertion of the animal without becoming snagged. The receiving end 7 of the rod 3 is also chamfered to allow for smooth insertion of the animal without becoming snagged. The predrilled holes 8 in the supporting base 3 facilitate installation of the device. The flat surface 9 of the back of the supporting base 2 allows for a secure installation to any surface. The guiding edge 10 of the supporting base 2 is beveled allowing for smooth insertion of the animal without becoming snagged. The closed end of the supporting base 2 has a chamfered edge 11 to allow for smooth operation and to protect the operator from sharp edges. The rod 3 of the device is attached below the guiding edge 10 of the supporting base 2 allowing for the animals head to orient itself in the proper angle while using the controlled “hyper extension” method (1) to facilitate breaking the animal's neck. The rod 3 of the device is attached below the guiding edge 10 of the supporting base 2 allowing for the animals head to be at the correct angle and the rod 3 giving proper support when using the “Sharp pull” method (2) to facilitate breaking the animal's neck. If the operator should require a wider or narrower opening of the device, the rod 3 may be adjusted using force either by hand or by inserting the rod 3 into a larger diameter and length pipe of sufficient rigidity and strength then with the added leverage afforded by the pipe, the opening 1 of the device is adjusted.

The operator may find a different method for using this device that is not listed and for use on different types of animals not listed. This device may be used for, but is not limited to slaughtering rabbits, hares, guinea pigs, ducks, geese, etc.

By making the device entirely of metal or similar material, it is both light and inexpensive as well as very sturdy. It may be easily removed or applied to a fixed support by means of a pair of screws or similar fastening devices, and since it is so easily removed, it may be carried from one place to the other, or to facilitate cleaning thereof.

This invention is not to be understood as restricted to the details set forth since these may be modified.

I claim:

1. A neck breaking apparatus usable on rabbits, poultry and other small animals comprising a rod and an L-shaped base frame attached together forming an inverted wedge.

2. The neck breaking apparatus according to claim 1, wherein the L-shaped base frame has holes drilled into it for ease of mounting to solid rigid structures.

3. The neck breaking apparatus according to claim 1, wherein the rod and the L-shaped base frame have rounded and beveled edges to protect the operator from injury as well as providing smooth and snag free surfaces for ease of insertion of the animal into said apparatus.

4. The neck breaking apparatus according to claim 1, wherein the rod has a curved end to allow easy insertion of the animal without snagging.

5. The neck breaking apparatus according to claim 1, wherein the L-shaped base frame has a curved shape to form a mouth for ease of insertion and to prevent snagging.

6. The neck breaking apparatus according to claim 1, wherein the L-shaped base frame and the rod are attached in a way that forms an open space between said rod and L-shaped base frame on one end which allows easy insertion of the animal into the apparatus by the operator.
